(19) United States
(12) Patent Application Publication
(10) Pub. No.: US 2025/0024311 A1
(43) Pub. Date: Jan. 16, 2025

(54) LINK SELECTION SYSTEM AND METHOD THEREOF

(71) Applicant: MEDIATEK Inc., Hsinchu City (TW)

(72) Inventors: Chia-Hsiang CHANG, Hsinchu City (TW); Ying-You LIN, Hsinchu City (TW)

(21) Appl. No.: 18/675,484

(22) Filed: May 28, 2024

Related U.S. Application Data
(60) Provisional application No. 63/513,582, filed on Jul. 14, 2023.

(51) Int. Cl. H04W 28/02; H04W 88/06

(52) U.S. Cl. CPC H04W 28/0263; H04W 28/0273; H04W 88/06

(57) ABSTRACT

A link selection system, for allocating a plurality of available links to a plurality of multi-link-device (MLD) stations, is provided. The link selection system includes the following elements. (1) A monitoring unit, for monitoring a traffic type of each of the MLD stations and a channel status of each of the available links. (2) A detecting unit, for detecting whether the traffic type is a QoS traffic or a heavy traffic and whether the channel status is a congested condition. (3) An arbitrating unit, for arbitrating a link configuration of the available links for the MLD stations based on the traffic type and the channel status. The available links are associated with a multi-link-operation (MLO) device.

This application claims the benefit of U.S. provisional application Ser. No. 63/513,582, filed Jul. 14, 2023, the disclosure of which is incorporated by reference herein in its entirety.

### TECHNICAL FIELD

The disclosure relates to a radio link allocation mechanism, and more particularly, relates to a link selection system and a method thereof for a multi-link-operation (MLO) device and corresponding multi-link-device (MLD) stations.

### BACKGROUND

As the progress of technology in wireless communication, flexible usage of spectrum resource can be achieved. Such as, in the WLAN communication system, the Wi-Fi 6 system can provide flexible usage of spectrum resource utilizing OFDMA mechanism, and user experiences of client devices can be enhanced regrading multi-client (or referred to as “multi-STAs”) QoS traffic.

Furthermore, in the Wi-Fi 7 system, a new technology with the multi-link-operation (MLO) is proposed. With the MLO mechanism, channel efficiency can be further enhanced, such that better user experiences can be achieved. For the MLO mechanism to achieve its best performance, multiple

STAs must be properly distributed to different links of the multi-link-operation (MLO) device.

In view of the above issues, it is desirable to have an improved link allocation mechanism for optimally distributing multiple STAs to the links of the MLO device.

### SUMMARY

According to one embodiment of the present disclosure, a link selection system is provided. The link selection system is for allocating a plurality of available links to a plurality of multi-link-device (MLD) stations. The link selection system includes the following elements. (1) A monitoring unit, for monitoring a traffic type of each of the MLD stations and a channel status of each of the available links. (2) A detecting unit, for detecting whether the traffic type is a QoS traffic or a heavy traffic and whether the channel status is a congested condition. (3) An arbitrating unit, for arbitrating a link configuration of the available links for the MLD stations based on the traffic type and the channel status. The available links are associated with a multi-link-operation (MLO) device.

According to another embodiment of the present disclosure, a link selection method is provided. The link selection method is for allocating a plurality of available links to a plurality of multi-link-device (MLD) stations. The link selection method includes the following steps. (1) Monitoring a traffic type of each of the MLD stations and a channel status of each of the available links. (2) Detecting whether the traffic type is a QoS traffic or a heavy traffic and whether the channel status is a congested condition. (3) Arbitrating a link configuration of the available links for the MLD stations based on the traffic type and the channel status. The available links are associated with a multi-link-operation (MLO) device.

### BRIEF DESCRIPTION OF THE DRAWINGS

FIG. 1 is a schematic diagram showing an operating environment for link selection mechanism of the present disclosure.

FIG. 2 is a block diagram of a link selection system according to an embodiment of the present disclosure.

FIGS. 3A and 3B are flow diagrams illustrating a link selection method according to an embodiment of the present disclosure.

FIG. 4 is a schematic diagram showing an example of link configuration of the links for the stations.

FIG. 5 is a schematic diagram showing another example of link configuration of the links for the stations.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

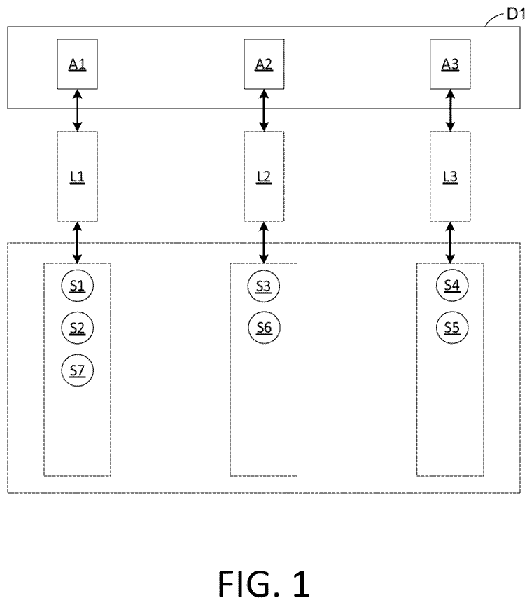

Referring to FIG. 1, which is a schematic diagram showing an operating environment for link selection mechanism of the present disclosure. The operating environment includes a multi-link-operation (MLO) device D1 and several multi-link-device (MLD) stations, e.g., MLD stations S1-S7. The

MLO device D1 and the corresponding MLD stations S1-S7 may conform to the Wi-Fi 7 specification, and each of the MLD stations S1-S7 may be referred to as a “STA” or a “client”. Such as, the MLD stations S1-S7 may include file transfer stations and video conference stations, etc. The link selection mechanism of the present disclosure is used to optimally distribute the MLD stations S1-S7 to different links of the MLO device D1 so as to optimize user experiences when using the MLD stations S1-S7.

The MLO device D1 may include several access points (AP), e.g., three APs A1-A3. Furthermore, the MLO device D1 may have several links, e.g., three links L1-L3 of different frequency bands. The links L1-L3 may be referred as “available links”. The link L1 may have a frequency band centered at 2.4 GHz and correspond to the AP A1. Furthermore, the link L2 may have a frequency band centered at 5 GHz and correspond to the AP A2. Moreover, the link L3 may have a frequency band centered at 6 GHz and correspond to the AP A3.

The links L1-L3 may have a link configuration for the MLD stations S1-S7, in which the links L1-L3 are correspondingly allocated to the MLD stations S1-S7. Under the link configuration of the example of FIG. 1, the link L1 is allocated to the MLD stations S1, S2 and S7, the link L2 is allocated to the MLD stations S3 and S6, and the link L3 is allocated to the MLD stations S4 and S5.

Each of the links L1-L3 has a channel status. The channel status may include a “congested condition”. Furthermore, each of the MLD stations S1-S7 has a traffic type. The traffic type may include a “QoS (Quality of Service) traffic”, a “background traffic” and a “heavy traffic”. When determining whether a MLD station has the QoS traffic, several QoS parameters may be considered. These QoS parameters include a latency, WFA QoS R1/R2/R3 classes, a throughput, WMM AC, ToS, DSCP, VIP priority, etc. In one example, when these QoS parameters indicate audio data packets or video data packets, the traffic type is determined as the QoS traffic.

On the other hand, when a MLD station does not have the QoS traffic, this MLD station is detected as having the background traffic. In addition, when a MLD station has the background traffic, this MLD station may be further detected as having the heavy traffic or not.

The link selection mechanism of the present disclosure is used to optimize the link configuration of the links L1-L3 for the MLD stations S1-S7 based on the channel status of each of the links L1-L3 and the traffic type of each of the MLD stations S1-S7.

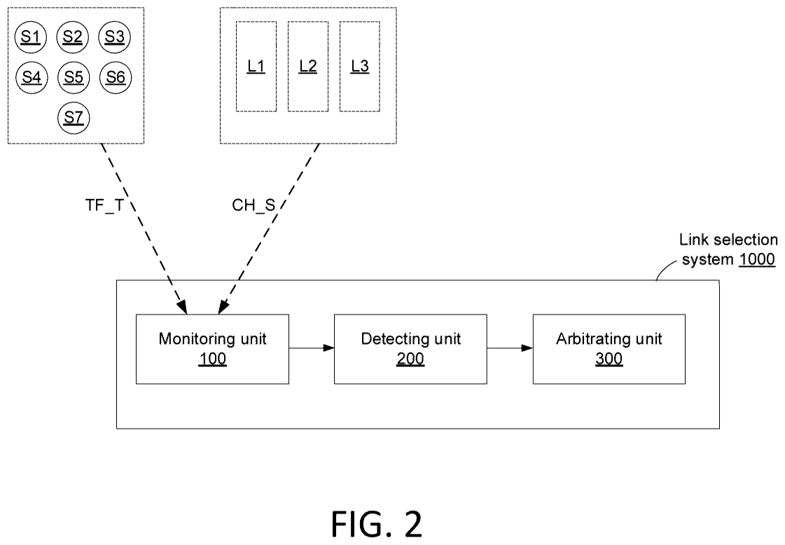

Referring to FIG. 2, which is a block diagram of a link selection system 1000 according to an embodiment of the present disclosure. The link selection system 1000 is used to perform the link selection mechanism. The link selection system 1000 includes a monitoring unit 100, a detecting unit 200 and an arbitrating unit 300. The link selection system 1000 may be implemented by a software program, e.g., a set of program codes stored in a non-volatile storage medium of the MLO device D1. When loaded from the non-volatile storage medium, the link selection system 1000 may be executed by a processor (e.g., a CPU or a GPU) of the MLO device D1. The monitoring unit 100, the detecting unit 200 and the arbitrating unit 300 may be sub-modules of program codes of the link selection system 1000.

Alternatively, the link selection system 1000 may be implemented by hardware. Such as, the link selection system 1000 may be a set of circuits, a chip of ASIC, a hardware processor or a FPGA disposed in the MLO device D1. The monitoring unit 100, the detecting unit 200 and the arbitrating unit 300 may be circuitry elements or hardware submodules of the link selection system 1000.

The monitoring unit 100 is configured to monitor the traffic type (notated as “TF_T” in FIG. 2) of each of the MLD stations (i.e., the MLD stations S1-S7 in FIG. 1). Also, the monitoring unit 100 is configured to monitor the channel status (notated as “CH_S” in FIG. 2) of each of the available links (i.e., the links L1-L3 in FIG. 1) of the MLO device D1.

Furthermore, the detecting unit 200 is operatively coupled to the monitoring unit 100 to receive the monitored traffic type and the monitored channel status. The detecting unit 200 is configured to detect whether the traffic type is the QoS traffic or the heavy traffic and whether the channel status is the congested condition.

Moreover, the arbitrating unit 300 is operatively coupled to the detecting unit 200 to receive the detection results of the detecting unit 200. The arbitrating unit 300 is configured to arbitrate the link configuration of the available links for the MLD stations based on the detected traffic type and channel status in the detection results.

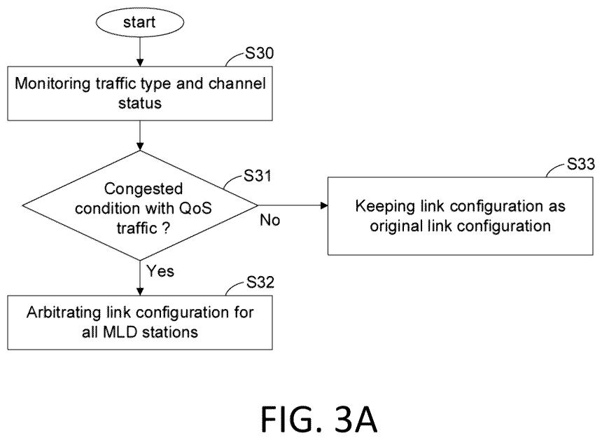

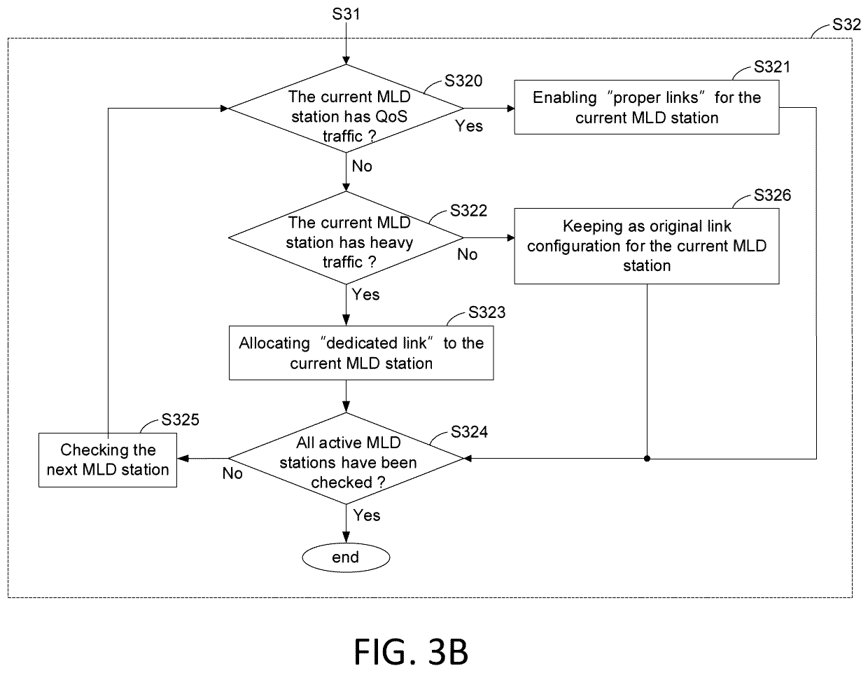

Detailed operations of the monitoring unit 100, the detecting unit 200 and the arbitrating unit 300 to perform the link selection mechanism, will be described in the following paragraphs by reference to FIGS. 3A, 3B, 4 and 5.

FIGS. 3A and 3B are flow diagrams illustrating a link selection method according to an embodiment of the present disclosure. The link selection method may be carried out with the link selection system 1000 in FIG. 2. Firstly, referring to FIG. 3A, the link selection method starts at step S30: monitoring the traffic type of each of the MLD stations S1-S7 by the monitoring unit 100, and monitoring the channel status of each of the links L1, L2 and L3 of the MLO device D1 by the monitoring unit 100. The traffic type and channel status may be evaluated based on usage ratios R1 and R2 of air-time. The usage ratio R1 of air-time is associated with all of the MLD stations S1-S7 (i.e., the MLD stations S1-S7 all together have one usage ratio R1). On the other hand, the usage ratio R2 of air-time is associated with each of the MLD stations S1-S7 (i.e., each of the MLD stations S1-S7 has its own usage ratio R2).

Then, at step S31, detecting (and hence determining) whether the traffic type is the QoS traffic and whether the channel status is the congested condition, by the detecting unit 200. In one example, when the usage ratio R1of air-time is greater than a threshold value TH_all, the channel status is detected as the congested condition. The threshold value TH_all is e.g., 75%.

When the traffic type of the MLD stations S1-S7 is detected as the QoS traffic and the channel status of the links L1-L3 is detected as the congested condition, step S32 is executed. Otherwise, step S33 is executed.

At step S33, the link configuration of the links L1-L3 for the MLD stations S1-S7 is kept as the original link configuration, i.e., link configuration of the links L1-L3 is kept un-changed. The original link configuration of links L1-L3 is shown in FIG. 1: the link L1 is allocated to three MLD stations S1, S2 and S7, the link L2 is allocated to two MLD stations S3 and S6, and the link L3 is allocated to two MLD stations S4 and S5.

On the other hand, at step S32, the link configuration of the links L1-L3 (for all of the MLD stations S1-S7) are arbitrated by the arbitrating unit 300. Detailed process of step S32 will be described in the following paragraphs by reference to FIG. 3B.

Referring to FIG. 3B, the detailed process of step S32 starts at step S320: detecting whether the traffic type of a current MLD station is the QoS traffic, by the detecting unit 200. (based on the order of the MLD stations S1-S7, the MLD station S1 is taken as the current MLD station, which is firstly analyzed). When the MLD station S1 is detected as having the QoS traffic, step S321 is then executed: all “proper links” are enabled for the MLD station S1. More particularly, all the links L1-L3 of the MLO device D1 are referred to as available links. Among the links L1-L3, some may be selected for allocating to MLD stations with QoS traffic, and some others may be selected for allocating to MLD stations with heavy traffic. The links selected for allocating to QoS traffic MLD stations may be referred to as “proper links” (also referred to as “the first links”). Furthermore, the link selected for allocating to heavy traffic MLD stations may be referred to as “dedicated link” (also referred to as “the second link”).

Otherwise, if it is detected that the current MLD station (i.e., the MLD station S1) does not have the QoS traffic, the detecting unit 200 may determines that the current MLD station has the background traffic. Then, step S322 is executed: further detecting whether the current MLD station has the heavy traffic (i.e., further detecting the background traffic as the heavy traffic or not). The usage ratio R2 of air-time may be utilized to determine the heavy traffic. Such as, when the usage ratio R2 of air-time for the current MLD station is greater than a threshold value TH_sta, this current MLD station is determined as having the heavy traffic (where the threshold value TH_sta is e.g., 25%). If the current MLD station does not have the heavy traffic, step S326 is executed: the link configuration for the current MLD station is kept as the original link configuration (i.e., the original link configuration is shown in FIG. 1: the link L1 is allocated to the MLD station S1).

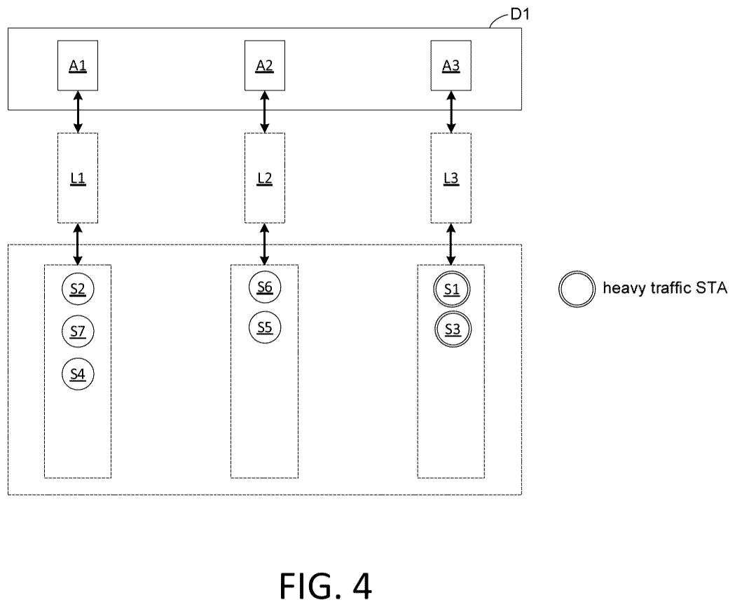

Otherwise, if the current MLD station has the heavy traffic, step S323 is executed: the arbitrating unit 300 is configured to select one link from the links L1-L3 as the “dedicated link”, and allocate such a “dedicated link” to the current MLD station having the heavy traffic, as shown in FIG. 4.

Referring to FIG. 4, which is a schematic diagram showing an example of link configuration of the links L1-L3 for the MLD stations S1-S7. At step S323 in FIG. 3B, the arbitrating unit 300 selects the link L3 as the “dedicated link” for heavy traffic MLD station. Therefore, the selected link L3 is allocated to the MLD station S1 (i.e., the current MLD station having heavy traffic).

Referring to FIG. 3B again, then, step S324 is executed: the arbitrating unit 300 is configured to browse whether all MLD stations S1-S7 (i.e., referred to as “active MLD stations”) have been checked for their traffic type. In this case, only the MLD station S1 has been checked, then executing step S325: checking the next MLD station (i.e., the MLD station S2).

Then, steps S320, S321, S322, S323 and/or S326 will be executed for the MLD station S2. Such as, the MLD station S2 is checked as having the background traffic (i.e., not the QoS traffic), and the MLD station S2 does not have the heavy traffic. Hence, step S326 is executed: link configuration for the MLD station S2 is kept as its original link configuration. As shown in FIG. 4, the link L1 is still allocated to the MLD station S2.

Then, at step S324, browsing whether all of the MLD stations S1-S7 have been checked. Since only two MLD stations S1 and S2 have been checked, then executing step S325: checking the next MLD station (i.e., the MLD station S3).

Similar schemes as the MLD stations S1 and S2 may be applied to the MLD station S3, in which steps S320, S321, S322, S323 and/or S326 are executed again. The MLD station S3 is checked as having the background traffic (i.e., not the QoS traffic) and with the heavy traffic, therefore, executing step S323 to allocate the “dedicated link” to MLD station S3. As shown in FIG. 4, the arbitrating unit 300 allocates the link L3 (i.e., the “dedicated link”) to the MLD station S3. Till, now, the link L3 is allocated to the heavy traffic MLD stations S1 and S3. On the other hand, the MLD stations S4 and S5 which originally occupy the link L3 as FIG. 1, may be distributed to other links. Such as, the MLD station S4 is assigned with the link L1, and the MLD station S5 is assigned with the link L2, as shown in FIG. 4.

Likewise, steps S320, S321, S322, S323 and/or S326 will be executed for the rest two MLD stations S6 and S7. Such as, the MLD stations S6 and S7 are checked as not having the QoS traffic and not having the heavy traffic. Hence, as shown in FIG. 4, link configuration for the MLD stations S6 and S7 are kept as their original link configuration in FIG. 1.

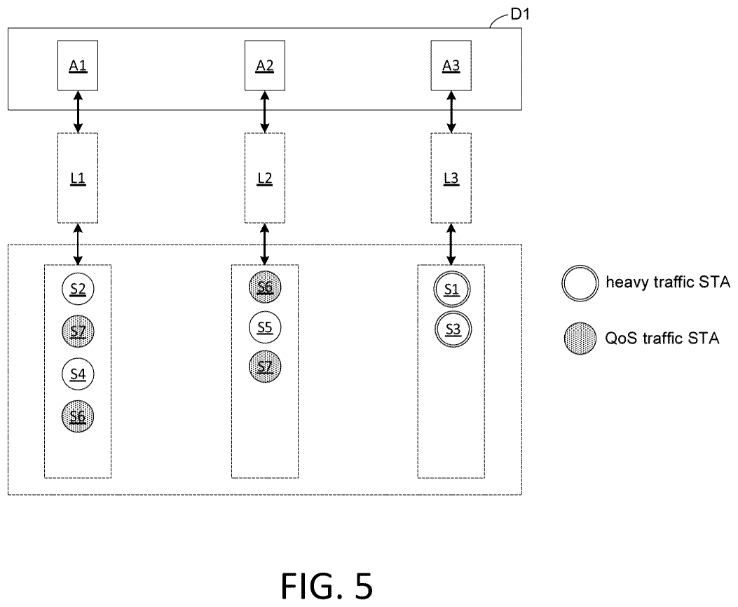

Alternatively, at step S320 if the MLD stations S6 and S7 are detected as having the QoS traffic, then executing step S321: the “proper links” are enabled for the MLD stations S6 and S7, as shown in FIG. 5.

Referring to FIG. 5, which is a schematic diagram showing another example of link configuration of the links L1-L3 for the MLD stations S1-S7. Since the link L3 is selected as “dedicated link” for heavy traffic MLD stations S1 and S3, this link L3 is not proper for QoS traffic MLD stations S6 and S7. On the other hand, the rest two links L1 and L2 may be selected as “proper links” and allocated to QoS traffic MLD stations S6 and S7. In this example, each of “proper links” L1 and L2 may be allocated to both MLD stations S6 and S7.

In still another example of link configuration of the links L1-L3 for the MLD stations S1-S7, more than one link may be selected as “dedicated link” for heavy traffic MLD stations (not shown in the figures). Such as, two links L2 and L3 are selected as “dedicated links” for heavy traffic MLD stations, while the rest link L1 is selected as “proper links” for QoS traffic MLD stations.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A link selection system, for allocating a plurality of available links to a plurality of multi-link-device (MLD) stations, the link selection system comprising:
a monitoring unit, for monitoring a traffic type of each of the MLD stations and a channel status of each of the available links;
a detecting unit, for detecting whether the traffic type is a QoS traffic or a heavy traffic and whether the channel status is a congested condition; and
an arbitrating unit, for arbitrating a link configuration of the available links for the MLD stations based on the traffic type and the channel status;
wherein the available links are associated with a multi-link-operation (MLO) device.

2. The link selection system according to claim 1, wherein when a first usage ratio of air-time for all of the MLD stations is greater than a first threshold value, the channel status is detected as the congested condition.

3. The link selection system according to claim 1, wherein when the traffic type is not the QoS traffic, the traffic type is determined as a background traffic.

4. The link selection system according to claim 1, wherein when a plurality of QoS parameters associated with one of the MLD stations indicate audio data packets or video data packets, the one of the MLD stations is detected as having the QoS traffic.

5. The link selection system according to claim 4, wherein at least one first link is/are selected from the available links and allocated to the one of the MLD stations having the QoS traffic.

6. The link selection system according to claim 1, wherein when a second usage ratio of air-time for one of the MLD stations is greater than a second threshold value, the one of the MLD stations is detected as having the heavy traffic.

7. The link selection system according to claim 6, wherein at least one second link is/are selected from the available links and allocated to the one of the MLD stations having the heavy traffic.

8. The link selection system according to claim 1, wherein when each of the MLD stations has neither the OoS traffic nor the heavy traffic, the link configuration of the available links are kept unchanged.

9. A link selection method, for allocating a plurality of available links to a plurality of multi-link-device (MLD) stations, the link selection method comprising:
monitoring a traffic type of each of the MLD stations and a channel status of each of the available links;
detecting whether the traffic type is a QoS traffic or a heavy traffic and whether the channel status is a congested condition; and
arbitrating a link configuration of the available links for the MLD stations based on the traffic type and the channel status;
wherein the available links are associated with a multi-link-operation (MLO) device.

10. The link selection method according to claim 9, wherein when a first usage ratio of air-time for all of the MLD stations is greater than a first threshold value, detecting the channel status as the congested condition.

11. The link selection method according to claim 9, wherein when the traffic type is not the QoS traffic, determining the traffic type as a background traffic.

12. The link selection method according to claim 9, wherein when a plurality of QoS parameters associated with one of the MLD stations indicate audio data packets or video data packets, detecting the one of the MLD stations as having the QoS traffic.

13. The link selection method according to claim 12, further comprising:
selecting at least one first link is/are from the available links; and
allocating the at least one first link to the one of the MLD stations having the QoS traffic.

14. The link selection method according to claim 9, wherein when a second usage ratio of air-time for one of the MLD stations is greater than a second threshold value, detecting the one of the MLD stations as having the heavy traffic.

15. The link selection method according to claim 14, further comprising:
selecting at least one second link is/are from the available links; and
allocating the at least one second link to the one of the MLD stations having the heavy traffic.

16. The link selection method according to claim 9, wherein when each of the MLD stations has neither the OoS traffic nor the heavy traffic, keeping the link configuration of the available links unchanged.
